(19) United States
(12) Patent Application Publication
(10) Pub. No.: US 2010/0060532 A1
(43) Pub. Date: Mar. 11, 2010

(54) VEHICLE HOLDER WITH WIRELESS SIGNAL ENHANCEMENT FUNCTION

(76) Inventors: Chung-Yuan Kuang, Taipei (TW); Zhi-Ciang Wang, Taipei (TW); Yi-Hao Syu, Taipei (TW)

Correspondence Address: Muncy, Geissler, Olds & Lowe, PLLC, P.O. BOX 1364, FAIRFAX, VA, 22038-1364, US

(21) Appl. No.: 12/536,942

(22) Filed: Aug. 6, 2009

(30) Foreign Application Priority Data
Sep. 9, 2008 (TW) 97134485

(51) Int. Cl. H01Q 1/32

(52) U.S. Cl. 343/713

(57) ABSTRACT

A vehicle holder with a wireless signal enhancement function is provided. A receiving antenna and a transmitting antenna are disposed on a holder. The receiving antenna is pivotally connected to the holder, and it may rotate relative to the holder to be adjusted to an optimal signal-receiving position. The wireless signal received by the receiving antenna is transmitted to the transmitting antenna directly, and then the transmitting antenna transmits the signal to a wireless communication device disposed in the vehicle holder in a wireless mode. Thus, the quality of the signals, especially GPS signals, is improved.

### BACKGROUND OF THE INVENTION

1. Field of the Invention

The invention relates to a vehicle holder with a wireless signal enhancement function to allow a wireless communication device to be fixed at the vehicle.

2. Description of the Related Art

The most common wireless communication devices are mobile phones, personal digital assistants (PDA) and global positioning systems (GPS). With the increasing requirement of portability, the wireless communication device is smaller and smaller. An antenna, as well as the wireless communication device, is minimized and even may be embedded in the body. However, this is a challenge to the quality of signal-receiving to the antenna.

To a mobile phone, since there are many base stations, generally the quality of signal is not affected much. However, to a PDA or a GPS using a satellite navigation system, since the number of the satellites is limited, the signal of the GPS is weak, and people always use the satellite navigation function in a vehicle, besides the shield function of the vehicle, the windscreen also reflects part of the GPS signal as a reflector.

In another aspect, since the PDA or the GPS is usually set to be erected, when the user drives a vehicle, a vehicle holder is always used to mount the PDA or the GPS. Since the GPS signal is transmitted by the satellite, the direction of the GPS signal is substantially vertical to the vehicle. However, the PDA or the GPS is disposed vertically. Thus, the quality of signal-receiving is worse. If the GPS or the PDA is disposed horizontally, the driver may feel inconvenient to see it or operate it.

Generally, when a user uses the PDA or the GPS to perform the navigation function, a group of antenna is needed to be additionally connected to improve the quality of signal-receiving. However, this may decrease the portability of the PDA or the GPS. In addition, connecting holes of the external antenna do not have unified specification, and sometimes different manufacturers or models have different specification, which makes it inconvenient to use the PDA or the GPS.

In the conventional technology, an antenna in the vehicle has an additional function to receive a GPS signal. Thus, the signal is enhanced by connecting the GPS to the antenna. In addition, a strip-shaped antenna is connected to a rearview mirror of the vehicle. Then, a coaxial cable is connected to the GPS in the vehicle. However, this may be achieved by designing the vehicle. If the GPS is disposed in other vehicle, the signal may not be enhanced, which is not flexible.

### BRIEF SUMMARY OF THE INVENTION

The invention discloses a vehicle holder with a wireless signal enhancement function. The holder includes a holder, a receiving antenna and a transmitting antenna.

The holder has an accommodating space for accommodating and fixing a wireless communication device. The receiving antenna is pivotally connected to the holder, and it may rotate relative to the holder to be adjusted to a preferable signal-receiving position. The receiving antenna then transmits the received wireless signal to the transmitting antenna in a wired mode. The transmitting antenna is embedded in the holder, and it may transmit signal transmitted by the receiving antenna in a wireless mode to transmit information. Then, the information is transmitted to the wireless communication device disposed on the holder. Since the receiving angle of the receiving antenna is adjustable to improve the quality of signal-receiving, and the wireless communication device does not need to be moved, operating and viewing the wireless communication device is not affected.

In another aspect, the wireless signal received by the receiving antenna also may be further enhanced through the filter and the amplifying circuit. The holder may provide power needed by the receiving antenna and the transmitting antenna by a vehicle charger. In addition, the wireless communication device may be charged by a USB cable.

These and other features, aspects and advantages of the present invention will become better understood with regard to the following description, appended claims, and accompanying drawings.

### BRIEF DESCRIPTION OF THE DRAWINGS

FIG. 1A and FIG. 1B are schematic diagrams showing the vehicle holder with the wireless signal enhancement function in an embodiment of the invention;

FIG. 2A and FIG. 2B are schematic diagrams showing the combination and rotation of the receiving antenna 20 of the vehicle holder with the wireless signal enhancement function in an embodiment of the invention;

FIG. 3A and FIG. 3B are schematic diagrams showing the detailed circuit of the receiving antenna of the vehicle holder with the wireless signal enhancement function in an embodiment of the invention;

FIG. 4 is a schematic diagram showing the usage state of the vehicle holder with the wireless signal enhancement function in an embodiment of the invention; and

FIG. 5A and FIG. 5B are schematic diagrams showing the vehicle holder with the wireless signal enhancement function in another embodiment of the invention.

### DETAILED DESCRIPTION OF THE EMBODIMENTS

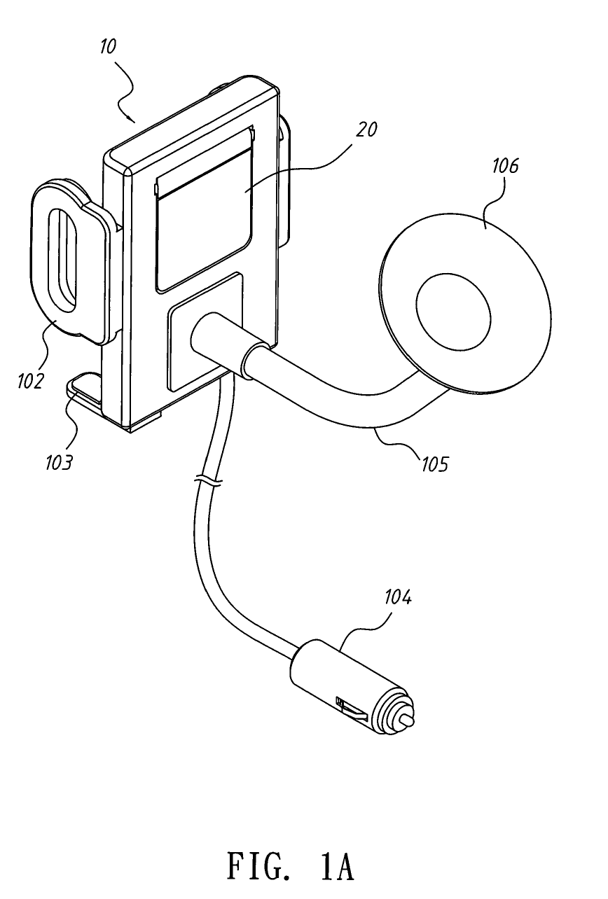

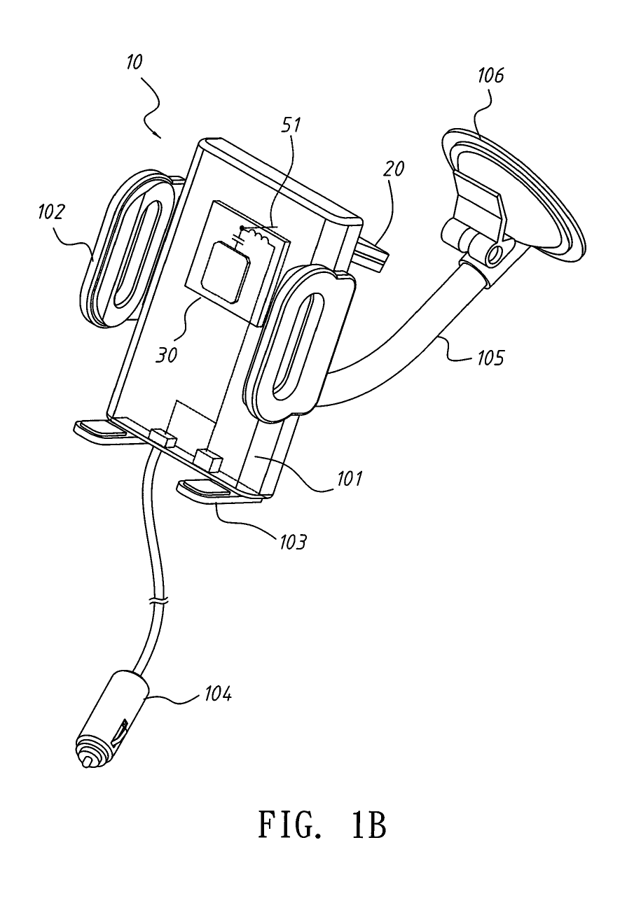

The invention discloses a vehicle holder with a wireless signal enhancement function. As shown in FIG. 1A and FIG. 1B, they are schematic diagrams showing the vehicle holder with a wireless signal enhancement function.

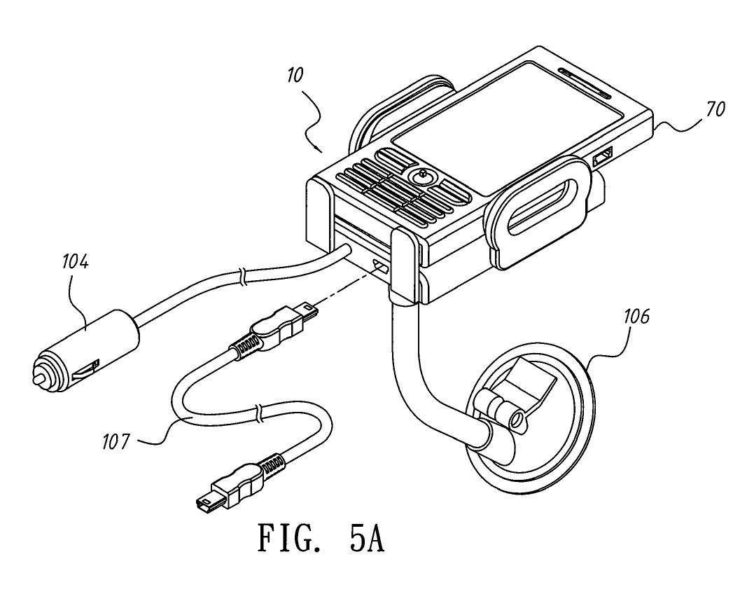

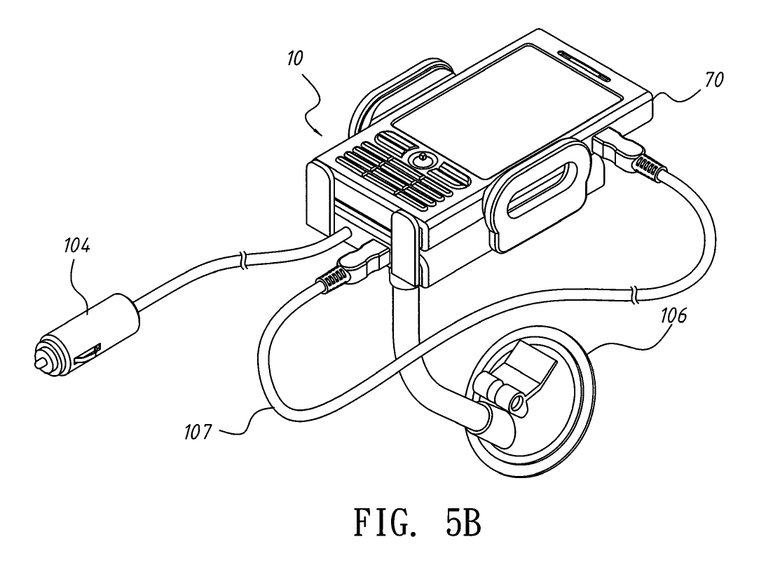

The vehicle holder with the wireless signal enhancement function includes a holder 10, a receiving antenna 20 and a transmitting antenna 30. The holder 10 has a back plate 101 and a fixture 102. The back plate 101 is substantially a flat plate, and the fixture 102 is disposed at both sides of the back plate 101 to form an accommodating space between the back plate 101 and the fixture 102 to accommodate the wireless communication device 70 (as shown in FIG. 5A). The fixture 102 is fixed at both sides of the wireless communication device 70 to hold the wireless communication device 70 and to prevent it from leaving the accommodating space.

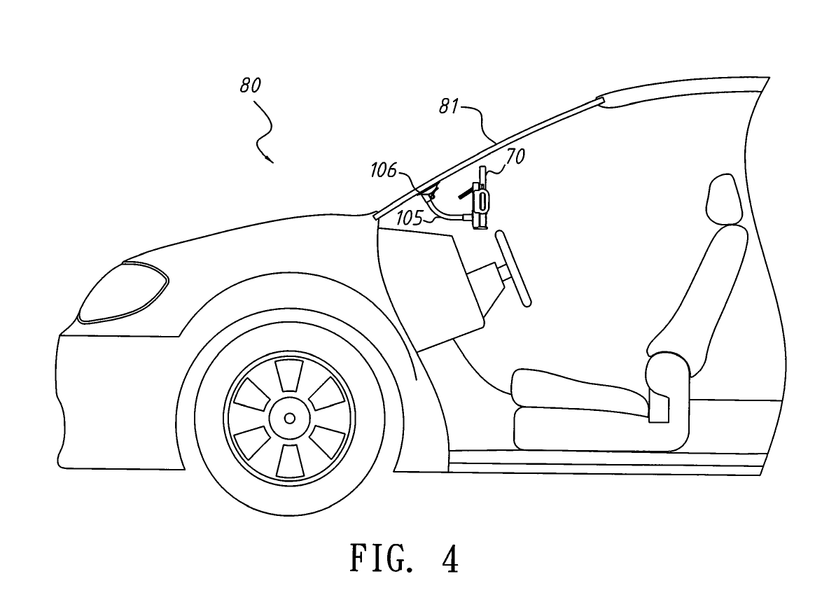

In another aspect, since the holder 10 is mounted on the vehicle 80, to make a user feel convenient to operate the wireless communication device 70, the holder is erected obliquely (as shown in FIG. 4). Thus, multiple block portions 103 are disposed at the bottom of the back plate 101 to prevent the wireless communication device 70 from sliding off.

The receiving antenna 20 is pivotally connected to the holder 10, and it may rotate relative to the holder 10, which is illustrated in detail in the following part. The receiving antenna may be adjusted to an optimal angle and position to receive a wireless signal such as a GPS signal (the GPS signal is taken as an example hereinbelow). Since the front of the back plate 101 of the holder 10 is used to accommodate the wireless communication device 70, and at the side of the holder 10 there are the fixture 102 and the block portions 103, the receiving antenna 20 may have no enough space to rotate. Thus, the receiving antenna 20 is preferably disposed at the back of the back plate 101 of the holder 10.

The transmitting antenna 30 is embedded in the holder 10 and is electrically connected to the receiving antenna 20. Thus, the GPS signal received by the receiving antenna 20 is transmitted to the transmitting antenna 30 in a wired mode. Then, information is transmitted outward. For example, the information may be transmitted to the wireless communication device 70 disposed on the holder 10.

Since the receiving antenna 20 and the transmitting antenna 30 need power when they are operated, the holder 10 further includes a vehicle charger 104 to be plugged in the vehicle 80 (as shown in FIG. 4) to provide power for the receiving antenna 20 and the transmitting antenna 30. In addition, a flexible pipe 105 is connected at the back of the holder 10, and a fixing component 106 is connected at the end of the flexible pipe 105. The fixing component 106 may be a sucker, a cramp, a hook or their combination to be fixed on the vehicle 80. Since the flexible pipe 105 is made of flexible material, the angle and position may be adjusted after it is fixed.

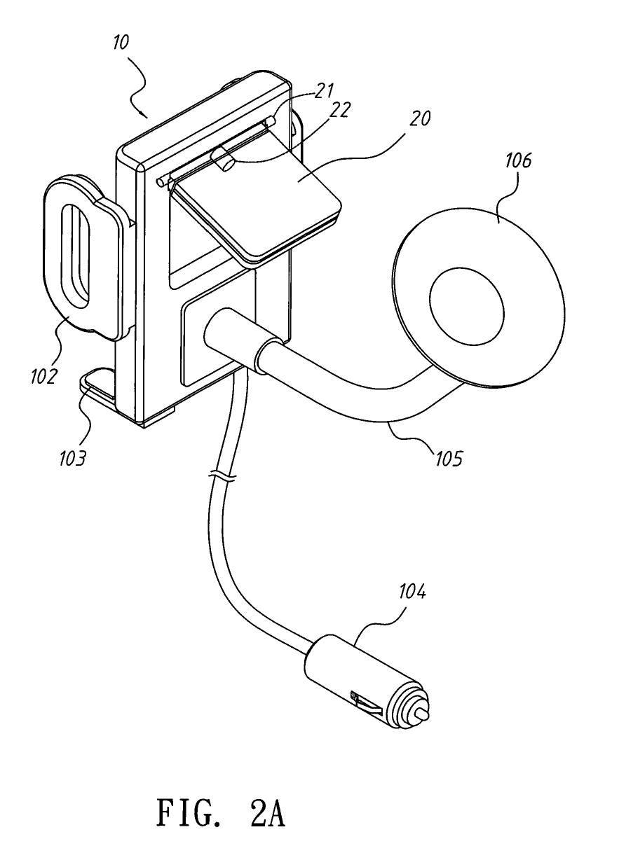

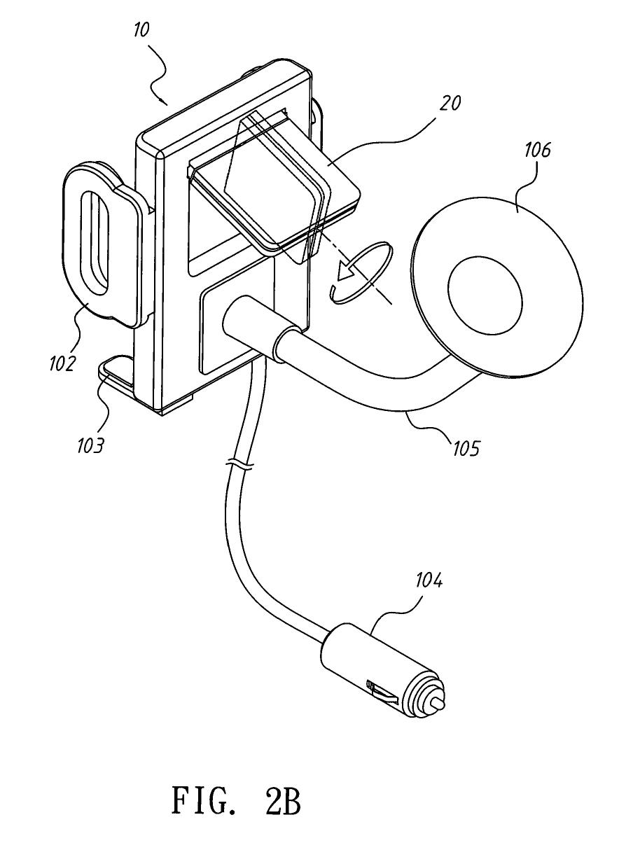

As shown in FIG. 2A and FIG. 2B, they are schematic diagrams showing the combination and rotation of the receiving antenna 20 of the vehicle holder having the wireless signal enhancement function in an embodiment of the invention.

To make the adjustable angle of the receiving antenna 20 more flexible, the receiving antenna 20 is pivotally connected to the holder 10 in a dual-axis pivot. The dual-axis pivot includes a first pivot 21 and a second pivot 22. The first pivot 21 is pivotally connected to the holder 10 to allow the receiving antenna 20 to overturn relative to the holder 10 (as shown in FIG. 2A). The second pivot 22 is disposed on the first pivot 21 to allow the receiving antenna 20 to rotate relative to the holder 10 around the second pivot 22 (as shown in FIG. 2B). Thus, due to the design of the dual-axis pivot, the receiving antenna 20 may rotate 360 degrees, and it may be adjusted to the optimal signal-receiving angle.

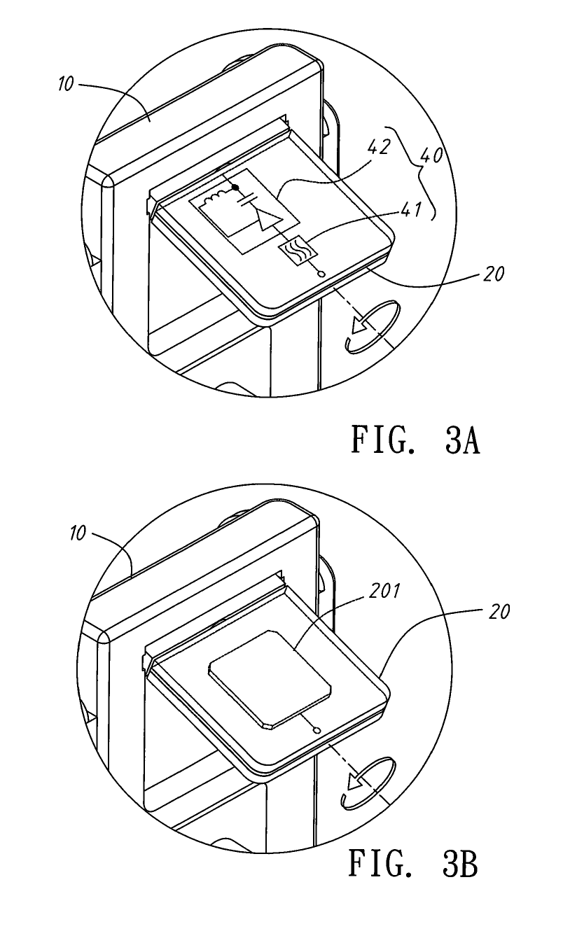

As shown in FIG. 3A and FIG. 3B, they are schematic diagrams showing the detailed circuit of the receiving antenna 20 of the vehicle holder with the wireless signal enhancement function in an embodiment of the invention.

A patch antenna 201 is disposed at one side of the receiving antenna 20 for receiving the GPS signal. The patch antenna 201 is an omni-directional antenna. However, the receiving antenna 20 is not limited to be the patch antenna 201. The received GPS signal is transmitted to a low noise amplifying circuit 40 at another side. Since the GPS signal is a low frequency signal, the low nose amplifying circuit 40 is needed to enhance the signal. The low noise amplifying circuit 40 includes a filter 41 and an amplifying circuit 42. After the GPS signal is received, the filter 41 is used to filter the signal only to keep the low frequency signal segment, and then the amplifying circuit 42 is used to amplify the signal.

The GPS signal is taken as an example hereinbelow. If other kinds of wireless signals are enhanced, the circuit also may be designed and changed according to requirements. In addition, the low noise amplifying circuit 40 is not limited to be disposed at one side of the receiving antenna 20, and it also may be disposed in the holder 10. Disposing the low noise amplifying circuit 40 at one side of the receiving antenna 20 may use the space most effectively.

As shown in FIG. B, after processed by the low noise amplifying circuit 40, the GPS signal is transmitted to the transmitting antenna 30 via a coaxial cable 51. Since the coaxial cable 51 is disposed in the second pivot 22 (as shown in FIG. 2A), the rotation and overturning of the receiving antenna 20 do not affect the transmission of the coaxial cable 51. Then, after the transmitting antenna 30 receives the GPS signal, information is transmitted to the wireless communication device 70 of the holder 10 in a wireless mode (as shown in FIG. 5A). The transmitting antenna 30 also may be a patch antenna.

Then, as shown in FIG. 4, it is a schematic diagram showing the usage state of the vehicle holder with the wireless signal enhancement function in an embodiment of the invention.

As shown in FIG. 4 and the preceding drawings, when the vehicle holder is used in a vehicle, it is fixed at the windscreen 81 of the vehicle 80 by the fixing component 106 to allow the user to see. The flexible pipe 105 also may be used to adjust the operation angle, and the vehicle holder is substantially erected with slight obliqueness. The receiving antenna 20 may be rotated and overturned to be adjusted to the optimal signal-receiving angle. To take the GPS signal as an example, since the GPS signal is transmitted by the satellite, the receiving antenna 20 may be adjusted to be horizontal to achieve the optimal angle. However, the actual situation may be changed according to different situations.

After the GPS signal is received by the receiving antenna 20, it is filtered and amplified. Then, it is transmitted by the transmitting antenna 30 in a wireless mode and received by the wireless communication device 70.

Then, as show in FIG. SA and FIG. 5B, they are schematic diagrams showing the vehicle holder with the wireless signal enhancement function in another embodiment of the invention.

In another aspect, since the holder 10 has a vehicle charger 104 to provide power, the holder 10 also may have a USB cable 107. The USB cable 107 is connected to the vehicle charger 104 (as shown in FIG. 1B). Thus, when the end of the USB cable 107 is connected to the wireless communication device 70, the wireless communication device 70 is charged.

In the vehicle holder with a wireless signal enhancement function, the antenna is disposed at the holder. In the conventional technology, an external antenna is needed when the quality of signal is not good. However, in the wireless communication device, the external antenna which is used to improve the quality of signal-receiving is not needed. The built-in filter and amplifying circuit also may further enhance the wireless signal. The wireless signal transmits information in a wireless mode, and thus, the wireless communication device does not need to have a unified specification, and this increases the applicability of the product.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A vehicle holder, comprising:
a holder having an accommodating space for accommodating a wireless communication device;
a receiving antenna pivotally connected to the holder to rotate relative to the holder and receive a wireless signal; and
a transmitting antenna embedded in the holder and connected to the receiving antenna, wherein after the wireless signal is received by the receiving antenna, it is transmitted to the wireless communication device in a wireless mode.

2. The vehicle holder according to claim 1, further comprising a fixing component connected to the holder.

3. The vehicle holder according to claim 1, further comprising a filter connected to the receiving antenna.

4. The vehicle holder according to claim 3, further comprising an amplifying circuit connected to the filter.

5. The vehicle holder according to claim 1, wherein the holder has a vehicle charger.

6. The vehicle holder according to claim 5, wherein the holder further comprises an USB cable connected to the vehicle charger to be further connected to the wireless communication device.

7. The vehicle holder according to claim 1, wherein the holder has a back plate and a fixture, and an accommodating space is formed between the back plate and the fixture.

8. The vehicle holder according to claim 1, wherein the receiving antenna is pivotally connected to the holder by a dual-axis pivot.

9. The vehicle holder according to claim 8, wherein the dual-axis pivot comprises a first pivot pivotally connected to the holder and a second pivot disposed at the first pivot to allow the receiving antenna to overturn relative to the holder round the first pivot and to rotate relative to the first pivot through the second pivot.
